(19) United States
(12) Patent Application Publication
(10) Pub. No.: US 2008/0075331 A1
(43) Pub. Date: Mar. 27, 2008

(54) Finger vein authentication input apparatus

(76) Inventors: Soichi Sakurai, Yokohama (JP); Yuichi Horiuchi, Hitachinaka (JP); Kyoichi Takahashi, Fujisawa (JP); Hitoshi Takizawa, Yokohama (JP)

Correspondence Address: MCDERMOTT WILL & EMERY LLP, 600 13TH STREET, N.W., WASHINGTON, DC, 20005-3096, US

(21) Appl. No.: 11/902,803

(22) Filed: Sep. 25, 2007

(30) Foreign Application Priority Data
Sep. 25, 2006 (JP) 2006-258236

(51) Int. Cl. G06K 9/00

(52) U.S. Cl. 382/115

(57) ABSTRACT

Within a finger vein authentication input apparatus, a finger positioning portion comprises a fingertip projection portion provided at a position corresponding to the tip of the finger when picking up an image thereof, protruding into the horizontal direction, soas to be in contact with a tip of a finger, horizontally, a finger pulp projection portion provided at the position corresponding to the tip of the finger when picking up the image thereof, protruding into the vertical direction, so as to be in contact with the tip of the finger, vertically, and a base guide portion provided at the position corresponding to the base side than a second joint of the finger when picking up the image thereof, having a configuration curved along the cross-section configuration of the finger, or a curved configuration including a projection portion at a center thereof, thereby increasing an accuracy of positioning the finger in the longitudinal direction thereof, and further lowering shift of angle of attaching the finger in the longitudinal direction thereof.

### BACKGROUND OF THE INVENTION

The present invention relates to a finger vein authentication input apparatus to be used for a personal certification or authentication, with reproduction of pattern information of a finger vein, and it relates to, in particular, a technology for improving an accuracy of positioning a finger thereon.

In recent years, from a viewpoint of safety management for properties and/or information, an expectation is increased for the personal authentication, and in particular, an attention is paid upon the authentication apparatus of using the finger vein, because of no change is caused therein for a lifetime of a human being, from viewpoints of difficulty of forgery, usability, and a sense of security.

The authentication technology for an authentication apparatus of utilizing the finger vein is discloses, for example, in Japanese Patent Laying-Open No. 2004-49705 (2004). In this Japanese Patent Laying-Open No. 2004-49705 (2004) is described a personal authentication apparatus, having a light source portion for irradiating a penetrating light upon an upper surface of a finger, an interference filter portion, an image pickup portion for picking up an image of the light penetrating through said interference filter portion, and an image process portion for processing a vein pattern or print that is outputted from that image pickup portion. In particular, there is disclosed a technology for providing the following: a finger bump portion 4, so as to bump a tip of finger thereon, at the deepest portion (or a bottom) of a finger insertion portion, for the purpose of shifting thereof, in particular, in the major axis of the finger, a triangle mark 1 indicative of a center of the finger inserted into a inlet portion of the finger insertion portion of a case, for the purpose of preventing the finger from shifting in the minor axis of the finger and also from rotating around the axis of the major axis of the finger, an upper finger base bump portion 4, to be bumped with a finger base portion in the finger insertion portion, for the purpose of presenting the finger 7 from shifting from the image pickup portion, and a projection portion 5 in front of the finger bump portion 4.

### SUMMARY OF THE INVENTION

In particular, in the finger vein authentication input apparatus, it is important to improve accuracy on the authentication, and for that purpose, it is a key to achieve an increase of the accuracy of positioning the finger therein. However, with the finger vein authentication input apparatus disclosed in the patent document mentioned above, although it has such the finger positioning parts therein, but there is still remained a problem for achieving the positioning with much higher accuracy.

According to the present invention, for accomplishing the increase of the authentication accuracy thereof, an object thereof is to provide a technology for lowering fluctuation or dispersion in positioning of a finger.

For accomplishing the object mentioned above, according to the present invention, there is provided a finger vein authentication input apparatus, for picking up an image of a vein authentication pattern of a finger with irradiating near infrared lights thereon, comprising: a finger positioning stand for positioning said finger thereon; a light source portion for irradiating the near infrared lights upon said finger; and an image pickup camera portion, being inputted with the near infrared lights penetrating through said finger, for converting into an image signal of the vein authentication pattern, wherein said finger positioning stand is provided at a position corresponding to a tip of said finger when picking up the image thereof, and has a fingertip projection portion protruding into a horizontal direction so as to be in contact with the tip of said finger, horizontally.

Further, according to the present invention, the finger vein authentication input apparatus, as described in the above, wherein said finger positioning portion further comprises a finger pulp projection portion, being provided at a position corresponding to the tip of said finger when picking up the image thereof, protruding into a vertical direction so as to contact with a pulp portion of said finger, vertically, and also a base guide portion, being provided at a position corresponding to a base side than a second joint of said finger when picking up the image thereof, and having a configuration being curved along a cross-section configuration of said finger.

According to the present invention, since it is possible to lower the fluctuation in positioning of a finger within the finger vein authentication input apparatus, thereby achieving an improvement on the accuracy of finger vein authentication.

### BRIEF DESCRIPTION OF THE DRAWINGS

Those and other objects, features and advantages of the present invention will become more readily apparent from the following detailed description when taken in conjunction with the accompanying drawings wherein:

FIG. 1 is a side view of a finger vein authentication input apparatus, according to an embodiment, in particular, for showing a principle portion thereof, briefly;

FIG. 2 is an upper view of the finger vein authentication input apparatus, according to the embodiment mentioned above, in particular, for showing a principle portion thereof, briefly;

FIG. 3 is a side view of a finger vein authentication input apparatus, according to other embodiment, in particular, for showing a principle portion thereof, briefly;

FIG. 4 is a side view of a finger vein authentication input apparatus, according to further other embodiment, in particular, for showing a principle portion thereof, briefly;

FIG. 5 is an upper view of a finger vein authentication input apparatus, according to further other embodiment, in particular, for showing a principle portion thereof, briefly;

FIG. 6 is an upper view of a finger vein authentication input apparatus, according to further other embodiment, in particular, for showing a principle portion thereof, briefly;

FIG. 7 is a side view of a finger vein authentication input apparatus, according to further other embodiment, in particular, for showing a principle portion thereof, briefly; and

FIG. 8 is a side view of a finger vein authentication input apparatus, according to further other embodiment, in particular, for showing a principle portion thereof, briefly.

### DESCRIPTION OF THE PREFERRED EMBODIMENTS

Hereinafter, embodiments according to the present invention will be fully explained by referring to the attached drawings.

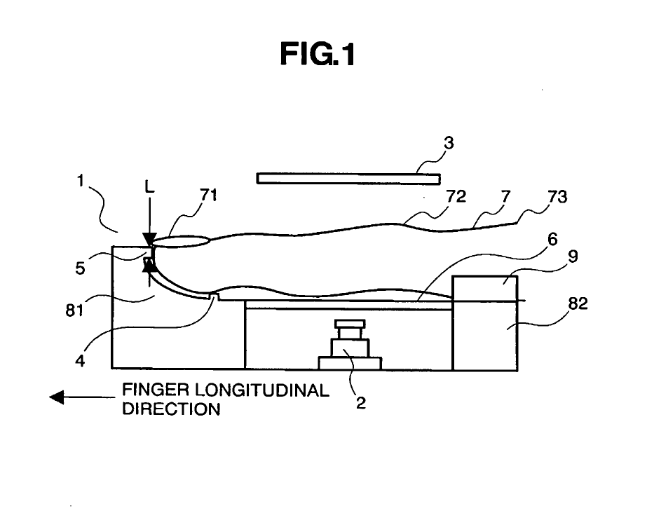

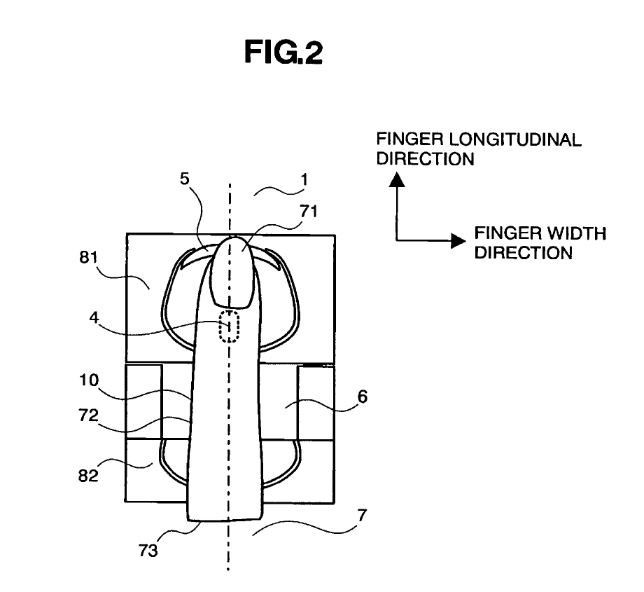

FIGS. 1 and 2 shows an side view of a finger vein authentication input apparatus, according to the present invention, and a side view thereof, in particular, for showing a principle portion thereof. In those FIGS. 1 and 2, a reference numeral 1 depicts the finger vein authentication input apparatus, 2 an image pickup portion, 3 a light source portion made of a LED or the like, for example, 4 a finger pulp projection portion, 5 a fingertip projection portion, 6 a filter, 7 a finger, 71 a fingernail, respectively. A finger positioning stand for fixing the finger 7 thereon is made up with a fingertip positioning stand 81 for fixing a tip portion of the finger 7, and a finger-base positioning stand 82 for fixing a base portion of the finger 7 thereon. A reference numeral 9 depicts a base guide portion.

Next, explanation will be made on a method for picking up a vein pattern of the finger 7. In FIG. 1, near infrared lights irradiating from the light source portion 3 penetrate through the finger 7, and reach to the image pickup portion 2. The filter 6 is provided for guiding only the near infrared lights, which penetrating through the finger, into the image pickup portion 2, but for shielding external lights other than those of the light source portion 3.

Because hemoglobin in the blood absorbs the near infrared lights, the near infrared lights cannot penetrate through the vein. With using this characteristic, a near infrared light image of vein is taken within the image pickup portion 2, and it is converted into a picture signal. Upon basis of the picture signal obtained, the vein is patterned, and then it is matched with the pattern, which is registered in advance, i.e., conducting the authentication.

As was mentioned above, since the authentication is made by the pattern matching in the finger vein authentication, it is important to lessen repetitive error of a vein pattern to be pickup, for the purpose of obtain an improvement of a rate of authentication. With the structures of the fingertip positioning stand 81 and the finger-base positioning stand 82, according to the present invention, it is possible to bring the setting position of the finger 7 to be constant, and therefore it is possible to reduce the repetitive error of the vein pattern, i.e., being effective for an increase of the authentication rate. Hereinafter, explanation will be made in details of the structures of the fingertip positioning stand 81 and the finger-base positioning stand 82.

As is shown in FIG. 1, for the purpose of preventing the positioning error in the direction of in major axis of the finger, the fingertip projection portion 5 is provided on the fingertip positioning stand 81. As is shown in FIG. 2, the fingertip projection portion 5 has a curved shape along with the configuration of the finger 7, so as to take a large area for contacting with the tip portion of the finger 7, and further as is shown in FIG. 1, the fingertip projection portion 5 has such the structure that it bumps on the tip portion of the finger 7 just below the fingernail 71, nearly at the right angles (90 degree) thereto.

For obtaining such the structures as was mentioned above, the inventors made evaluations on a sense of contacting, for each contacting portion of the finger 7 with the finger positioning stand. In more details thereof, the contacting sense evaluation is conducted while pushing a rod of circular cross-section of +1.5 mm, on each portion at the tip of the finger 7 at weight of 50 g. As a result thereof, it is apparent that the contacting sensitivity is the strongest at the position just below the fingernail 71, among those contacting sensitivities made along a central line 10 extending into the longitudinal direction of the finger 7, and that it is gradually weaken, directing from the fingernail 7 to the pulp of finger.

From such the results of contacting senses, it can be seen that the positioning error of the finger can be made small, by applying the structures of bumping the projection portion at the tip portion of the finger 7, below the fingernail 71, at around the right angles (90 degree), as was mentioned above. For the purpose of increasing this effect, as is shown in FIG. 2, the fingertip projection portion 5 is curved in the shape thereof, along with the tip configuration of the finger 7, so as to obtain a large contact area between the tip portion of the finger 7.

Also, for determining an optimal length “L” on the cross-section of the fingertip projection portion 5 shown in FIG. 1, it is necessary to take safety and a sense of incompatibility when contacting, or the like, other than the characteristics of sensitivity of the sense of contacting mentioned above, into the consideration thereof, and from a result of total estimation made by us, it is apparent that the above-mentioned can be satisfied by selecting the optimal length “L” on the cross-section within a range from 0.3 mm to 3 mm. The fingertip projection portion 5 shown in FIG. 1 has an angular shape, in the side surface configuration thereof, but it may be in an elliptic shape, approximately, or may be a crescent shape of half-circle on one side thereof.

Or, as is shown in FIG. 2, for the purpose of preventing the finger from the positioning error thereof, in particular, in the width direction of the finger 7 on the fingertip positioning stand 81, the finger pulp projection portion 4 is positioned at a pulp of the finger, as is shown in FIGS. 1 and 2, and it lies on a center line 10 in the longitudinal direction of the finger, as is shown in FIG. 2. As is shown in FIG. 2, the length of the finger pulp projection portion 4 in the longitudinal direction of the finger is longer, comparing to that in the width direction thereof.

From the estimation results mentioned above, upon the sensitivity of the contacting sense at each of the contacting points on the finger 7 between the finger positioning stand, because the sensitivity of the contacting sense on the pulp portion of the finger 7 is low comparing to that below the fingernail 71, therefore for compensating that, the length in the longitudinal direction of the finger is made longer than that in the width direction of the finger. In the similar manner to that mentioned above, for determining the finger pulp projection portion 4, it is also necessary to take the safety and the sense of incompatibility when contacting or the like, into the consideration thereof, other than the characteristics of sensitivity of the contacting sense, and from the result of the total estimation made by us, it is apparent that the above mentioned can be satisfied by setting the finger pulp projection portion 4 within a range of ratio from 2.0 to 8.0, of the length of in the longitudinal direction of the finger to that in the width direction of the finger.

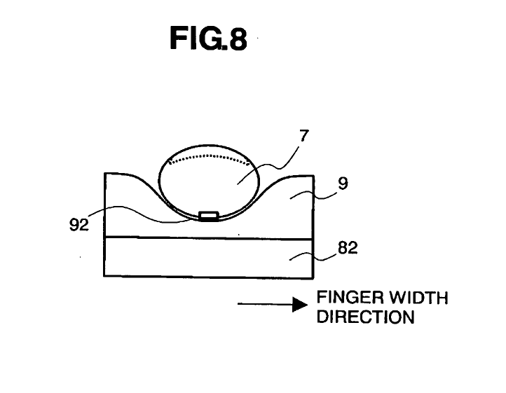

Further, as is shown in FIG. 1, a base guide portion 9 is disposed on the finger-base positioning stand 82, thereby preventing the finger 7 from shifting in the finger width direction at the base portion thereof, when positioning. FIG. 7 shows the cross-section view of an outline of the finger-base positioning stand 82. From this FIG. 7, a finger contact portion 91 has a configuration curving along the cross-section view of the finger 7 locating in a middle portion between a second joint portion 72 of the finger 7 and base joint portion 73 thereof. This feature means that the finger 7 is fixed at the base portion in the finger width direction, and then it is possible to make the shifting in the finger width direction small. Further, as is shown in FIG. 8, for the purpose of increasing the positioning accuracy of the finger 7, a projection portion 92 may be provided at a center portion thereof.

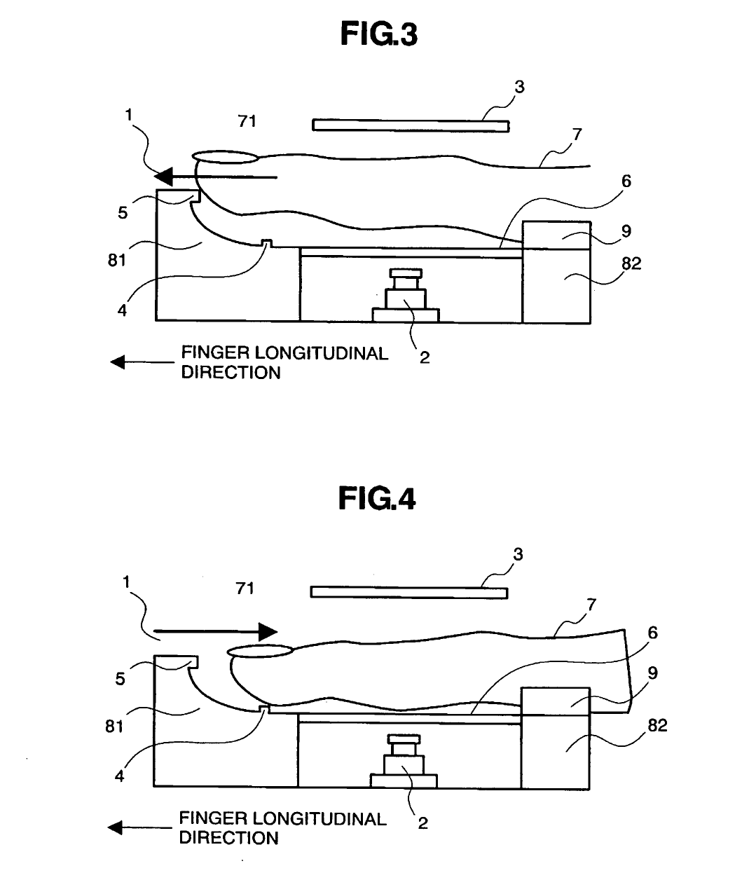

Next, explanation will be made on the situation of increasing the positioning accuracy of the finger, with provision of the fingertip projection portion 5, the finger pulp projection portion 4, and the finger contact portion 91, by referring to FIGS. 3 to 6.

As is shown in FIGS. 3 and 4, with provision of the fingertip projection portion 5 on the fingertip positioning stand 81, no shifting is caused on the finger 7 into the longitudinal direction thereof, as shown by a thick arrow in the figure, and therefore, it is possible to achieve a finger vein authentication input apparatus 1 having a superior accuracy of repetitive positioning. In particular, for increasing a recognition rate of the finger vein authentication input apparatus 1, an improvement of the accuracy of positioning, in particular, in the longitudinal direction of the finger, is important, more than the positioning accuracy of the finger in the width direction thereof, from a viewpoint of the system. In particular, according to the present invention, as is shown in FIGS. 3 and 4, there is also provided the fingertip projection portion 5 at the position, corresponding to the portion of the finer 7, where the sensitivity of the contacting sense is sharpest at the tip portion thereof, and with providing a sentence for explanation, such as, “Please contact a tip portion of the finger 7 with the fingertip projection portion 5 when positioning the finger 7” or the like, for example, it is possible to increase the positioning accuracy, in particular, in the longitudinal direction of the finger, without causing the shift of positioning as is shown in FIGS. 3 and 4.

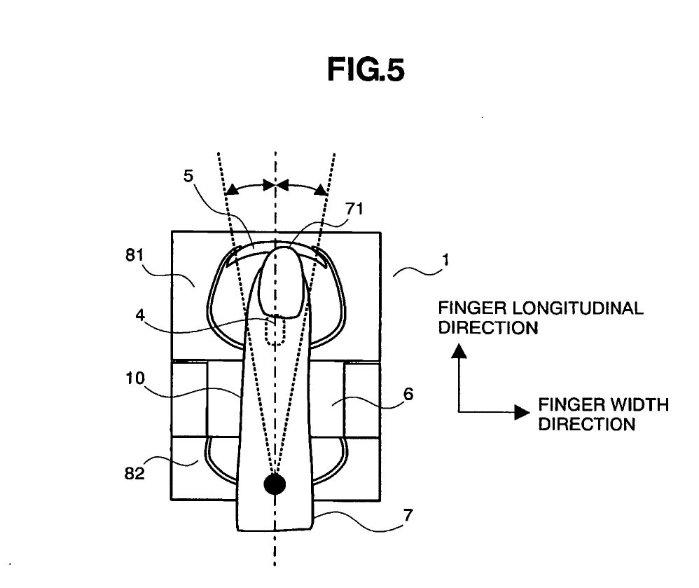

Also, as shown in FIG. 5, with provision of the finger pulp projection portion 4 on the fingertip positioning stand 81, it is possible to obtain the finger vein authentication input apparatus 1, being superior in the accuracy of repetitive positioning, without rotating the finger 7 around the finger-base positioning stand 82 into the width direction of the finger as is shown by the thick arrow in the figure.

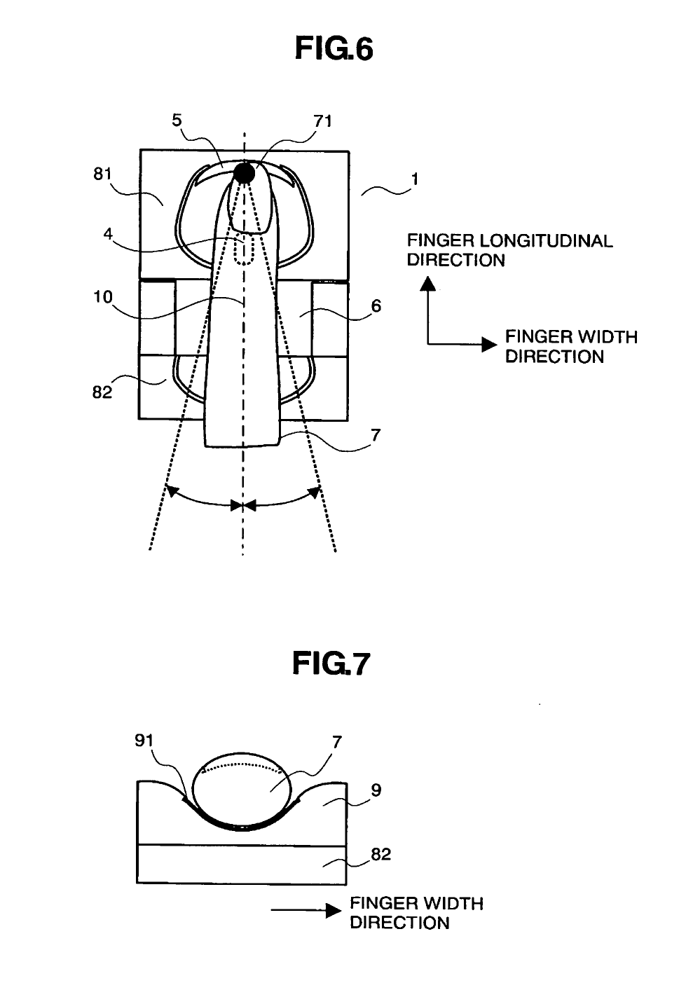

Or, as is also shown in FIG. 6, with provision of the base guide portion 9 on the finger-base positioning stand 82, it is possible to obtain the finger vein authentication input apparatus 1, being superior in the accuracy of repetitive positioning, without rotating the finger 7 around the tip portion of the finger 7 into the width direction of the finger as is shown by the thick arrow in the figure.

According to the present invention, because of the structures of the finger positioning stand, having the fingertip positioning stand and the finger base positioning stance, wherein the fingertip projection portion and the finger pulp projection portion are provided on the fingertip positioning portion, while providing the guide portion along the finger configuration on the finger base positioning stand, it is possible to obtain a large merit or advantages, i.e., maintaining high accuracy of positioning of the finger, with an aid of the fingertip projection portion that is provided on the fingertip positioning portion, against the position shift when positioning the finger in the longitudinal direction thereof, while maintaining high accuracy of positioning of the finger, with an aid of the finger pulp projection portion that is provided on the fingertip positioning portion, against the position shift of the fingertip portion in the width direction of thereof, or with an aid of the finger base guide portion that is provided on the finger base positioning stand, against the position shift in the width direction of the finger at the finger base portion thereof.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A finger vein authentication input apparatus, for picking up an image of a vein authentication pattern of a finger with irradiating near infrared lights thereon, comprising:
a finger positioning stand for positioning said finger thereon;
a light source portion for irradiating the near infrared lights upon said finger; and
an image pickup camera portion, being inputted with the near infrared lights penetrating through said finger, for converting into an image signal of the vein authentication pattern, wherein
said finger positioning stand is provided at a position corresponding to a tip of said finger when picking up the image thereof, and has a fingertip projection portion protruding into a horizontal direction so as to be in contact with the tip of said finger, horizontally.

2. The finger vein authentication input apparatus, as described in the claim 1, wherein said fingertip projection portion has an angular or an ellipse or a crescent configuration, approximately, protruding in the horizontal direction.

3. The finger vein authentication input apparatus, as described in the claim 2, wherein said fingertip projection portion has a configuration protruding in the horizontal direction, from 0.3 mm to 3 mm.

4. The finger vein authentication input apparatus, as described in the claim 1, wherein said finger positioning portion further comprises a finger pulp projection portion, being provided at a position corresponding to the tip of said finger when picking up the image thereof, protruding into a vertical direction so as to contact with a pulp portion of said finger, vertically.

5. The finger vein authentication input apparatus, as described in the claim 4, wherein a projection configuration of said finger pulp projection portion is disposed on a central line in longitudinal direction of the finger, and length thereof in the finger longitudinal direction is longer than that in finger width direction.

6. The finger vein authentication input apparatus, as described in the claim 5, wherein the projection configuration of said finger pulp projection portion is in a ratio from 2.0 to 8.0, between the length in the finger longitudinal direction and the length in the finger width direction.

7. The finger vein authentication input apparatus, as described in the claim 1, wherein said finger positioning stand further comprises a base guide portion, being provided at a position corresponding to a base side than a second joint of said finger when picking up the image thereof, and having a configuration being curved along a cross-section configuration of said finger.

8. The finger vein authentication input apparatus, as described in the claim 7, wherein said base guide portion has a projection portion at a central portion of the curved configuration thereof.

9. A finger vein authentication input apparatus, for picking up an image of a vein authentication pattern of a finger with irradiating near infrared lights thereon, comprising:
an image pickup portion, being inputted with the near infrared lights penetrating through said finger, for picking up a vein pattern;
a fingertip projection portion disposed in an upper portion of said image pickup portion, protruding into a horizontal direction, so as to be in contact with the tip of said finger, horizontally; and
a finger pulp projection portion disposed in the upper portion of said image pickup portion, and provided on a central lone in a longitudinal direction of said finger at a position corresponding to a pulp of said finger when picking up an image thereof, while protruding in a vertical direction, so as to be in contact with the pulp of said finger, vertically.

10. The finger vein authentication input apparatus, as described in the claim 9, wherein
said fingertip projection portion has an angular or an ellipse or a crescent configuration, approximately, protruding in the horizontal direction, and
said finger pulp projection portion is longer in length into a finger longitudinal direction, comparing to length thereof into a finger width direction.

11. A finger vein authentication input apparatus, for picking up an image of a vein authentication pattern of a finger with irradiating near infrared lights thereon, comprising:
an image pickup portion, being inputted with the near infrared lights penetrating through said finger, for picking up a vein pattern;
a fingertip projection portion disposed in an upper portion of said image pickup portion, protruding into a horizontal direction, so as to be in contact with the tip of said finger, horizontally;
a finger pulp projection portion disposed in the upper portion of said image pickup portion, being provided on a central lone in a longitudinal direction of said finger at a position corresponding to a pulp of said finger when picking up an image thereof, while protruding in a vertical direction, so as to be in contact with the pulp of said finger, vertically; and
a base guide portion disposed in the upper portion of said image pickup portion, being provided at a position corresponding to a base side than a second joint of said finger when picking up the image thereof, and having a configuration being curved along a cross-section configuration of said finger.

12. The finger vein authentication input apparatus, as described in the claim 11, wherein
said fingertip projection portion has an angular or an ellipse or a crescent configuration, approximately, protruding in the horizontal direction,
said finger pulp projection portion is longer in length into a finger longitudinal direction, comparing to length thereof into a finger width direction, and
said base guide portion has a projection portion at a central portion of the curved configuration thereof.
